(19) United States
(12) Patent Application Publication
(10) Pub. No.: US 2024/0353597 A1
(43) Pub. Date: Oct. 24, 2024

(54) IMAGE CAPTURING LENS

(71) Applicant: GUANGZHOU LUXVISIONS INNOVATION TECHNOLOGY LIMITED, GUANGZHOU (CN)

(72) Inventor: Chuan-Hui Liu, GUANGZHOU (CN)

(73) Assignee: GUANGZHOU LUXVISIONS INNOVATION TECHNOLOGY LIMITED, GUANGZHOU (CN)

(21) Appl. No.: 18/409,800

(22) Filed: Jan. 11, 2024

(30) Foreign Application Priority Data
Apr. 24, 2023 (CN) 202310448544.3

(51) Int. Cl. G02B 3/12; G02B 9/60; G02B 13/18

(52) U.S. Cl. CPC G02B 3/12; G02B 9/60; G02B 13/18

(57) ABSTRACT

An image capturing lens including a cemented lens is provided. The cemented lens has a positive refracting power and includes a spheric lens and a liquid lens. In addition to the cemented lens, the image capturing lens has 4 or 5 lenses with refracting powers.

### CROSS-REFERENCE TO RELATED APPLICATION

This application claims the priority benefit of China application no. 202310448544.3, filed on Apr. 24, 2023. The entirety of the above-mentioned patent application is hereby incorporated by reference herein and made a part of this specification.

### BACKGROUND

### Technical Field

The disclosure relates to an optical device; more particularly, the disclosure relates to an image capturing lens.

### Description of Related Art

Optical characteristics of optical lenses, such as a surface shape, a refractive index, and a curvature radius, are frequently contingent on manufacturing process of the optical lenses, thus leading to inherent limitations. Specifically, in the context of aspheric lenses, the current reliance on a complex molding process necessitates substantial manufacturing expenses. Therefore, there exists a pressing demand for technological advancements that facilitate the production of diverse optical lenses through a more streamlined and cost-effective process.

### SUMMARY

The disclosure provides an image capturing lens, which has a flexibility to adjust an overall refractive index, a surface shape, and a curvature radius, among other optical characteristics.

In an embodiment of the disclosure, an image capturing lens is provided, and the image capturing lens includes a cemented lens. The cemented lens has a positive refracting power and includes a spheric lens and a liquid lens. In addition to the cemented lens, the image capturing lens has 4 or 5 lenses with refracting powers.

Based on the above, the image capturing lens provided in one or more of the embodiments of the disclosure incorporates both the liquid lens and a solid lens to create the cemented lens. In response to the high plasticity of the liquid lens, the overall refractive index, the surface shape, the curvature radius, and other optical characteristics of the cemented lens are dynamically adjusted. This breakthrough surpasses manufacturing constraints associated with conventional solid lenses.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute apart of this specification. The drawings illustrate exemplary embodiments of the disclosure and, together with the description, serve to explain the principles of the disclosure.

FIG. 1A is a schematic view illustrating an image capturing lens according to a first embodiment of the disclosure. FIG. 1B and FIG. 1C are schematic views illustrating a field curvature of the image capturing lens according to the first embodiment. FIG. 1D is a schematic diagram illustrating a distortion of the image capturing lens according to the first embodiment.

FIG. 2A is a schematic view illustrating an image capturing lens according to a first embodiment of the disclosure. FIG. 2B and FIG. 2C are schematic views illustrating a field curvature of the image capturing lens according to the first embodiment. FIG. 2D is a schematic diagram illustrating a distortion of the image capturing lens according to the first embodiment.

FIG. 3A is a schematic view illustrating an image capturing lens according to a first embodiment of the disclosure. FIG. 3B and FIG. 3C are schematic views illustrating a field curvature of the image capturing lens according to the first embodiment. FIG. 3D is a schematic diagram illustrating a distortion of the image capturing lens according to the first embodiment.

### DESCRIPTION OF THE EMBODIMENTS

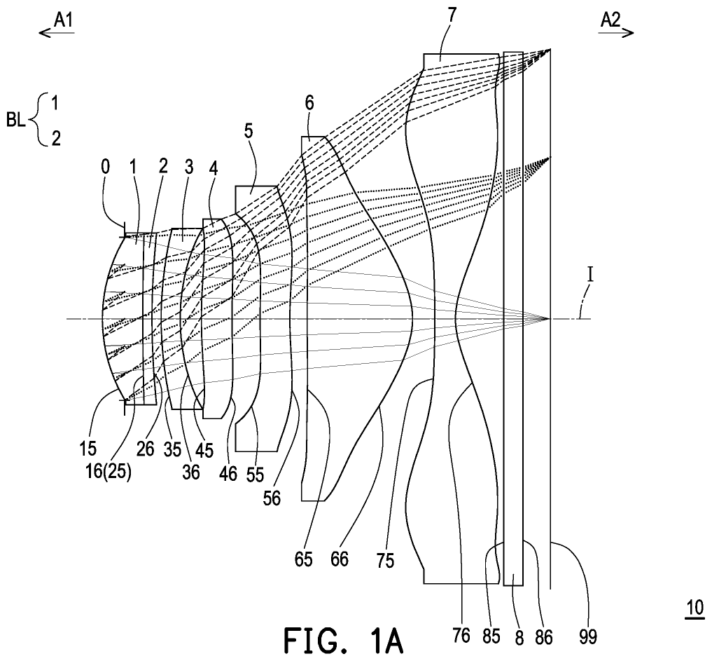

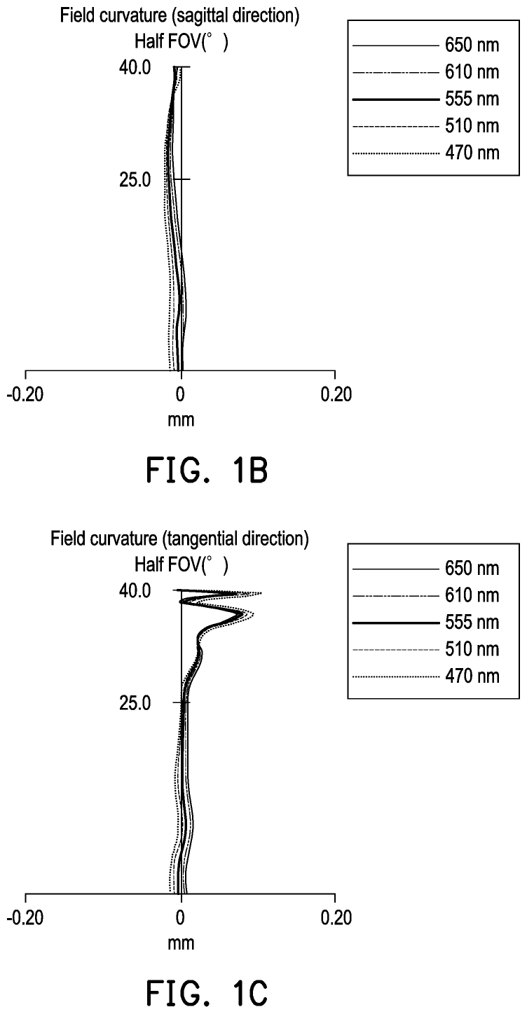

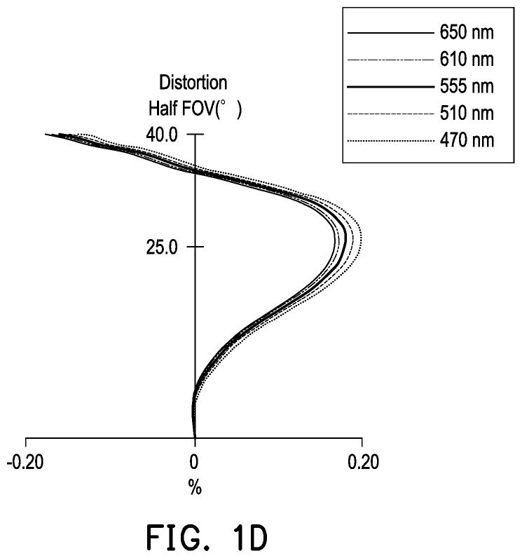

Please refer to FIG. 1A, which is a schematic view illustrating an image capturing lens according to a first embodiment of the disclosure. An image capturing lens 10 provided in the first embodiment of the disclosure sequentially includes an aperture 0, lenses 1 to 7, and a filter 8 along an optical axis I of the image capturing lens 10 from an object side A1 to an image side A2. The lens 1 is a spheric lens, the lens 2 is a liquid lens, and the lenses 1 and 2 are cemented to form a cemented lens BL. When light rays emitted from an object to be shot enter the image capturing lens 10 and sequentially pass through the aperture 0, the lenses 1, 2, 3, 4, 5, 6, 7, and the filter 8, an image is formed on an image plane 99. The filter 8, for instance, is an infrared cut-off filter, which allows light rays with appropriate wavelengths (such as infrared or visible light) to pass through and filters out the infrared waveband that is intended to be filtered out. The filter 8 is disposed between the lens 7 and the image plane 99. Note that the object side A1 is a side facing the object to be shot, while the image side A2 is a side facing the image plane 99.

In this embodiment, each of the lenses 1, 2, 3, 4, 5, 6, 7, and the filter 8 of the image capturing lens 10 has an object side surface 15, 25, 35, 45, 55, 65, 75, and 85 facing the object side A1 and allowing imaging light to pass through, and each of the lenses 1, 2, 3, 4, 5, 6, 7, and the filter 8 has an image side surface 16, 26, 36, 46, 56, 66, 76, and 86 facing the image side A2 and allowing the imaging light to pass through. In this embodiment, the lenses 1 and 2 are cemented together through the image side surface 16 of the lens 1 and the object side surface 25 of the lens 2, thus forming the cemented lens BL with a positive refracting power. In this embodiment, the aperture 0 is disposed at the object side A1 of the lens 1.

It should be noted that the image capturing lens provided in one or more of the embodiments of the disclosure incorporates a liquid lens and a solid lens to form the cemented lens BL. The remarkable plasticity of the liquid lens enables dynamic adjustments to the overall refractive index, the surface shape, the curvature radius, and other optical characteristics of the cemented lens BL, which represents a significant leap beyond the manufacturing limitations typically tied to the conventional solid lenses.

According to one or more of the embodiments of the disclosure, a refractive index of the spheric lens 1 falls within a range from 1.5 to 1.96, the liquid lens 2 may include ultraviolet (UV) resin, a refractive index of the liquid lens 2 falls within a range from 1.5 to 1.62, and a diameter of the liquid lens 2 falls within a range from 1.0 mm to 6.0 mm, which should however not be construed as a limitation in the disclosure. In other embodiments, other highly plastic droplets may be applied to manufacture the liquid lens 2.

The cemented lens BL has a positive refracting power, an optical axis region on the object side surface 15 of the cemented lens BL is a convex surface, an optical axis region on the image side surface 26 of the cemented lens BL is a concave surface, the object side surface 15 is a spheric surface, and the image side surface 26 is an aspheric surface. Specifically, by cementing the liquid lens 2 on the easier-to-mold spheric lens 1, the aspheric image side surface 26 is generated, whereby the aspheric cemented lens BL is formed. This greatly reduces the difficulty of manufacturing aspheric lenses as provided in the related art.

The lens 3 has a negative refracting power, an optical axis region on the object side surface 35 of the lens 3 is a convex surface, an optical axis region on the image side surface 36 of the lens 3 is a concave surface, and both the object side surface 35 and the image side surface 36 are aspheric surfaces.

The lens 4 has a positive refracting power, an optical axis region on the object side surface 45 of the lens 4 is a convex surface, an optical axis region on the image side surface 46 of the lens 4 is a concave surface, and both the object side surface 45 and the image side surface 46 are aspheric surfaces.

The lens 5 has a negative refracting power, an optical axis region on the object side surface 55 of the lens 5 is a convex surface, an optical axis region on the image side surface 56 of the lens 5 is a concave surface, and both the object side surface 55 and the image side surface 56 are aspheric surfaces.

The lens 6 has a positive refracting power, an optical axis region on the object side surface 65 of the lens 6 is a convex surface, an optical axis region on the image side surface 66 of the lens 6 is a convex surface, and both the object side surface 65 and the image side surface 66 are aspheric surfaces.

The lens 7 has a negative refracting power, an optical axis region on the object side surface 75 of the lens 7 is a concave surface, an optical axis region on the image side surface 76 of the lens 7 is a concave surface, and both the object side surface 75 and the image side surface 76 are aspheric surfaces.

Other detailed optical data provided in the first embodiment are shown in Table 1. A full field of view (FOV) of the image capturing lens 10 is 80°:

TABLE 1

| | | Curvature | | | |
|---|---|---|---|---|---|
| | | radius | Pitch | Refractive | Abbe |
| Element | Surface | (mm) | (mm) | index | number |
| Lens 1 | Object side surface 15 | 1.715 | 0.440 | 1.52 | 64.17 |
| | Image side surface 16 | 30.657 | 0.100 | 1.51 | 55.65 |
| Lens 2 | Image side surface 26 | 7.638 | 0.100 | | |
| Lens 3 | Object side surface 35 | 3.654 | 0.208 | 1.64 | 22.41 |
| | Image side surface 36 | 2.168 | 0.231 | | |
| Lens 4 | Object side surface 45 | 5.816 | 0.333 | 1.54 | 55.99 |
| | Image side surface 46 | 9.982 | 0.306 | | |
| Lens 5 | Object side surface 55 | 8.662 | 0.324 | 1.64 | 22.41 |
| | Image side surface 56 | 4.190 | 0.188 | | |
| Lens 6 | Object side surface 65 | 13.057 | 1.149 | 1.54 | 55.99 |
| | Image side surface 66 | −0.839 | 0.242 | | |
| Lens 7 | Object side surface 75 | −15.338 | 0.226 | 1.54 | 55.99 |
| | Image side surface 76 | 0.829 | 0.525 | | |
| Filter 8 | Object side surface 85 | Infinite | 0.210 | 1.52 | 64.17 |
| | Image side surface 86 | Infinite | 0.300 | | |
| | Image plane 99 | Infinite | 0.000 | | |

In Table 1, a pitch of the object side surface 15 (as shown in Table 1 as 0.440 mm) is a thickness of the lens 1 on the optical axis I, and a pitch of the image side surface 16 (as shown in Table 1 as 0.100 mm) is a thickness of the lens 2 on the optical axis I, a pitch of the image side surface 26 (as shown in Table 1 as 0.100 mm) is a distance between the image side surface 26 of the lens 2 and the object side surface 35 of the lens 3, i.e., a gap on the optical axis I between the cemented lens BL and the lens 3, and the rest may be deduced therefrom.

As shown in Table 1, the thickness of the liquid lens 2 is 0.100 mm, which should however not be construed as a limitation in the disclosure. In some embodiments, the thickness of the liquid lens 2 may decrease as its refractive index increases, and the thickness of the liquid lens 2 may be less than 0.100 mm.

In addition, due to the high plasticity of the liquid lens, a curvature radius of the image side surface 26 of the liquid lens 2 (7.638 mm, as shown in Table 1) may be different from a curvature radius of the image side surface 16 of the spheric lens 1 (30.657, as shown in Table 1), so that the cemented lens BL may have the aspheric image side surface 26 with a curvature radius of 7.638 mm. In other words, a curvature radius of the object side surface 25 of the liquid lens 2 may be different from the curvature radius of the image side surface 26 of the liquid lens 2, which should however not be construed as a limitation in the disclosure. In some embodiments, the curvature radius of the object side surface 25 of the liquid lens 2 is the same as the curvature radius of the image side surface 26.

In the present embodiment, the object side surfaces 35, 45, 55, 65, and 75 of the lenses 3, 4, 5, 6, and 7 and the image side surfaces 26, 36, 46, 56, 66, and 76 of the lenses 2, 3, 4, 5, 6, and 7 are all aspheric surfaces, and these aspheric surfaces are defined by the following formula (1):

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad ( 1 )$$

Y: a distance between a point on an aspheric curve and the optical axis;
Z: an aspheric depth, i.e., a vertical distance between a point located on the aspheric surface and spaced from the optical axis by a distance Y and a tangent plane tangent to a vertex of the aspheric surface on the optical axis;
R: a curvature radius of the lens surface;
K: conic coefficient;
a₂ᵢ: the 2i-th order aspheric coefficient.

In the present embodiment, the conic coefficient K in the formula (1) and various aspheric coefficients are as shown in Table 2. In Table 2, the column marked by a number 26 represents that the aspheric coefficients of the image side surface 26 of the lens 2, and other numbers are interpreted in the same manner.

TABLE 2

| Surface | K | a₄ | a₆ | a₈ | a₁₀ |
|---|---|---|---|---|---|
| 26 | 0.00E+00 | −2.35E−02 | 1.98E−02 | 5.62E−03 | −9.44E−03 |
| 35 | 0.00E+00 | −5.05E−02 | 1.92E−02 | 1.30E−01 | −2.74E−01 |
| 36 | 0.00E+00 | −1.25E−02 | −7.16E−02 | 3.74E−01 | −7.00E−01 |
| 45 | 0.00E+00 | −1.54E−02 | −1.47E−01 | 3.54E−01 | −6.41E−01 |
| 46 | 0.00E+00 | −2.95E−01 | −3.72E−02 | 4.99E−03 | 6.28E−03 |
| 55 | 0.00E+00 | −5.48E−01 | −4.27E−02 | −8.64E−03 | −2.59E−03 |
| 56 | 0.00E+00 | −5.83E−01 | 1.63E−01 | 2.96E−02 | 8.27E−03 |
| 65 | 0.00E+00 | −3.57E−01 | 1.14E−02 | −2.34E−02 | 1.99E−02 |
| 66 | 0.00E+00 | −1.09E−01 | 2.73E−02 | −7.07E−02 | 1.36E−02 |
| 75 | 0.00E+00 | −1.04E−01 | 2.78E−01 | −7.64E−02 | −6.81E−03 |
| 76 | 0.00E+00 | −1.01E+00 | 2.48E−01 | −5.76E−02 | −2.82E−02 |
| Surface | a₁₂ | a₁₄ | a₁₆ | a₁₈ | a₂₀ |
| 26 | −7.61E−03 | 4.61E−03 | 0.00E+00 | 0.00E+00 | 0.00E+00 |
| 35 | 2.73E−01 | −1.45E−01 | 3.27E−02 | 0.00E+00 | 0.00E+00 |
| 36 | 7.35E−01 | −4.12E−01 | 9.92E−02 | 0.00E+00 | 0.00E+00 |
| 45 | 6.67E−01 | −3.93E−01 | 1.02E−01 | 0.00E+00 | 0.00E+00 |
| 46 | 3.40E−03 | 1.08E−03 | 2.23E−04 | 0.00E+00 | 0.00E+00 |
| 55 | −9.96E−04 | 1.15E−04 | −8.33E−05 | 0.00E+00 | 0.00E+00 |
| 56 | −2.27E−03 | −2.38E−03 | −2.66E−03 | 0.00E+00 | 0.00E+00 |
| 65 | −4.66E−03 | 2.29E−03 | 3.67E−03 | 3.15E−03 | −9.49E−04 |
| 66 | 1.76E−02 | 7.32E−03 | 5.97E−03 | 4.80E−03 | 1.69E−03 |
| 75 | 1.14E−02 | −6.27E−03 | 3.55E−03 | −2.16E−03 | 4.88E−04 |
| 76 | −2.75E−02 | 2.89E−04 | 1.19E−02 | 6.03E−03 | 2.19E−03 |

Please refer to FIG. 1B to FIG. 1D. FIG. 1B illustrates a field curvature aberration curve in a sagittal direction when light with respective wavelengths of 470 nm, 510 nm, 555 nm, 610 nm, and 650 nm respectively enters the image capturing lens 10 provided in the first embodiment. FIG. 1C illustrates the field curvature aberration curve in a tangential direction when light with respective wavelengths of 470 nm, 510 nm, 555 nm, 610 nm, and 650 nm respectively enters the image capturing lens 10 provided in the first embodiment. FIG. 1D illustrates a distortion curve when light with respective wavelengths of 470 nm, 510 nm, 555 nm, 610 nm, and 650 nm respectively enters the image capturing lens 10 provided in the first embodiment.

In the two field curvature aberration curves shown in FIG. 1B and FIG. 1C, the field curvature aberrations of the five representative wavelengths fall within ±0.20 mm across the entire FOV, indicating that the image capturing lens 10 provided in the first embodiment of the disclosure effectively eliminates the aberrations. In the distortion curve shown in FIG. 1D, the distortion aberrations of the five representative wavelengths are less than 3.4407% across the entire FOV, indicating that the image capturing lens 10 provided in the first embodiment of the disclosure has the favorable imaging quality.

In order to fully demonstrate various embodiments of the disclosure, other embodiments of the disclosure are described below. Note that the reference numbers and some content provided in the previous embodiments are also used in the following embodiments, where the same reference numbers serve to represent the same or similar components, and the description of the same technical content is omitted. The description of the omitted parts may be referred to as those provided in the previous embodiments and will not be repeated hereinafter.

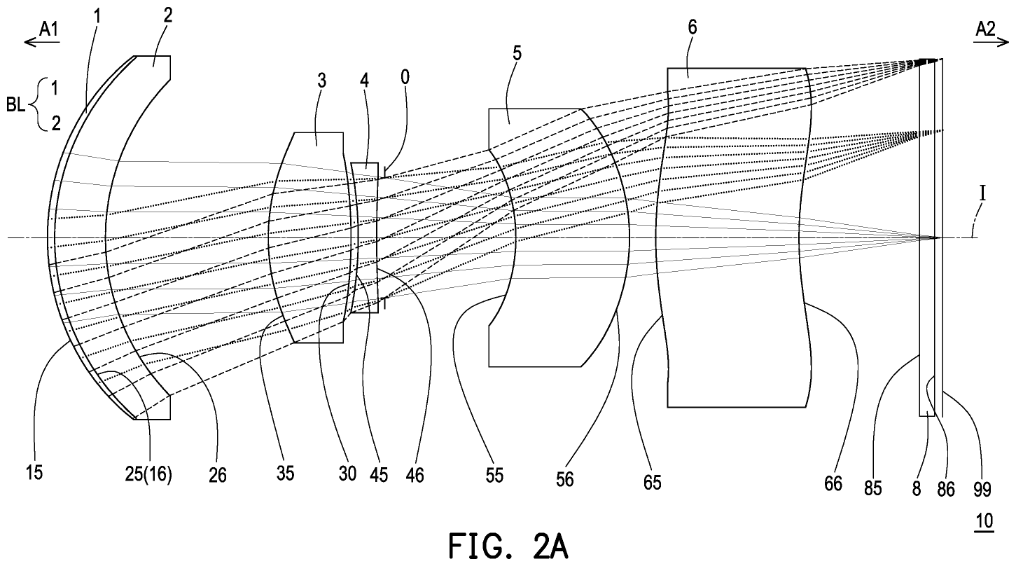

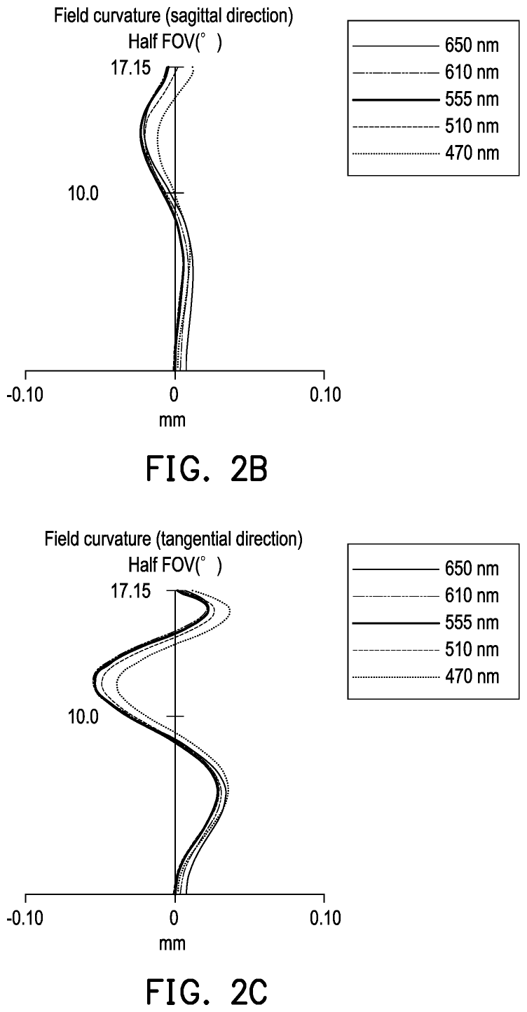

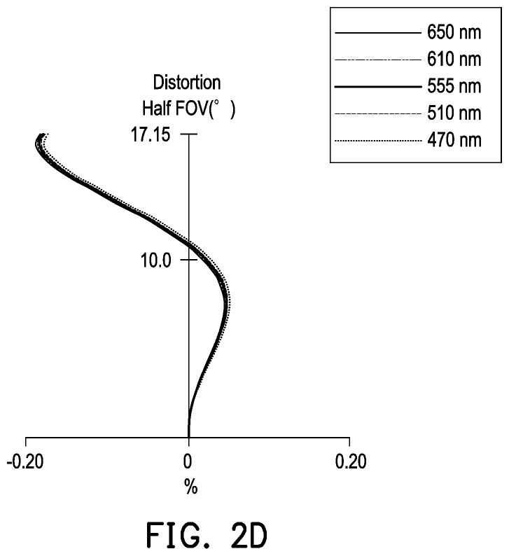

Please refer to FIG. 2A, which is a schematic view illustrating an image capturing lens according to a second embodiment of the disclosure. An image capturing lens 10 provided in the second embodiment of the disclosure sequentially includes lenses 1 to 4, an aperture 0, lenses 5 and 6, and a filter 8 along an optical axis I of the image capturing lens 10 from an object side A1 to an image side A2. The lens 1 is a spheric lens, the lens 2 is a liquid lens, and the lenses 1 and 2 are cemented to form a cemented lens BL. When light rays emitted from an object to be shot enter the image capturing lens 10 and sequentially pass through the lenses 1 to 4, the aperture 0, the lenses 5 and 6, and the filter 8, an image is formed on an image plane 99. The filter 8 is disposed between the lens 6 and the image plane 99.

In this embodiment, each of the lenses 1, 2, 3, 4, 5, 6, and the filter 8 of the image capturing lens 10 has an object side surface 15, 25, 35, 45, 55, 65, and 85 facing the object side A1 and allowing imaging light to pass through, and each of the lenses 1, 2, 3, 4, 5, 6, and the filter 8 has an image side surface 16, 26, 36, 46, 56, 66, and 86 facing the image side A2 and allowing the imaging light to pass through. In this embodiment, the lenses 1 and 2 are cemented together through the image side surface 16 of the lens 1 and the object side surface 25 of the lens 2, thus forming the cemented lens BL with a positive refracting power.

The cemented lens BL has a positive refracting power, an optical axis region on the object side surface 15 of the cemented lens BL is a convex surface, an optical axis region on the image side surface 26 of the cemented lens BL is a concave surface, the object side surface 15 is a spheric surface, and the image side surface 26 is an aspheric surface. Specifically, by cementing the liquid lens 2 on the easier-to-mold spheric lens 1, the aspheric object side surface 15 is generated, whereby the aspheric cemented lens BL is formed. This greatly reduces the difficulty of manufacturing aspheric lenses as provided in the related art.

The lens 3 has a positive refracting power, an optical axis region on the object side surface 35 of the lens 3 is a convex surface, an optical axis region on the image side surface 36 of the lens 3 is a convex surface, and both the object side surface 35 and the image side surface 36 are aspheric surfaces.

The lens 4 has a negative refracting power, an optical axis region on the object side surface 45 of the lens 4 is a concave surface, an optical axis region on the image side surface 46 of the lens 4 is a concave surface, and both the object side surface 45 and the image side surface 46 are aspheric surfaces.

The lens 5 has a positive refracting power, an optical axis region on the object side surface 55 of the lens 5 is a concave surface, an optical axis region on the image side surface 56 of the lens 5 is a convex surface, and both the object side surface 55 and the image side surface 56 are aspheric surfaces.

The lens 6 has a positive refracting power, an optical axis region on the object side surface 65 of the lens 6 is a convex surface, an optical axis region on the image side surface 66 of the lens 6 is a concave surface, and both the object side surface 65 and the image side surface 66 are aspheric surfaces.

The lens 7 has a negative refracting power, an optical axis region on the object side surface 75 of the lens 7 is a concave surface, an optical axis region on the image side surface 76 of the lens 7 is a concave surface, and both the object side surface 75 and the image side surface 76 are aspheric surfaces.

Other detailed optical data provided in the second embodiment are shown in Table 3. The full FOV of the image capturing lens 10 is 34.3°.

TABLE 3

| | | Curvature | | Refrac- | |
|---|---|---|---|---|---|
| | | radius | Pitch | tive | Abbe |
| Element | Surface | (mm) | (mm) | index | number |
| Lens 1 | Object side surface 15 | 3.354 | 0.09 | 1.59 | 30.94 |
| Lens 2 | Object side surface 25 | 3.354 | 0.709 | 1.73 | 28.32 |
| | Image side surface 26 | 3.149 | 2.274 | | |
| Lens 3 | Object side surface 35 | 2.896 | 1.156 | 1.54 | 55.99 |
| | Image side surface 36 | −6.780 | 0.100 | | |
| Lens 4 | Object side surface 45 | −5.318 | 0.258 | 1.64 | 22.41 |
| | Image side surface 46 | 17.668 | 0.113 | | |
| Aperture 0 | | Infinite | 1.831 | | |
| Lens 5 | Object side surface 55 | −2.384 | 1.588 | 1.54 | 55.99 |
| | Image side surface 56 | −2.764 | 0.367 | | |
| Lens 6 | Object side surface 65 | 5.633 | 2.000 | 1.64 | 22.41 |
| | Image side surface 66 | 5.031 | 1.553 | | |
| Filter 8 | Object side surface 85 | Infinite | 0.210 | 1.52 | 64.17 |
| | Image side surface 86 | Infinite | 0.113 | | |
| | Image plane 99 | Infinite | — | | |

In Table 3, a pitch of the object side surface 15 (as shown in Table 3 as 0.100 mm) is a thickness of the lens 1 on the optical axis I, and a pitch of the object side surface 25 (as shown in Table 3 as 0.409 mm) is a thickness of the lens 2 on the optical axis I, a pitch of the image side surface 26 (as shown in Table 3 as 2.274 mm) is a distance between the image side surface 26 of the lens 2 and the object side surface 35 of the lens 3, i.e., a gap on the optical axis I between the cemented lens BL and the lens 3, and the rest may be deduced therefrom.

In the present embodiment, the object side surfaces 15, 35, 45, 55, and 65 of the lenses 1, 3, 4, 5, and 6 and the image side surfaces 36, 46, 56, and 66 of the lenses 3, 4, 5, and 6 are all aspheric surfaces, and these aspheric surfaces are defined according to the formula (1).

In the present embodiment, the conic coefficient K in the formula (1) and various aspheric coefficients are as shown in Table 4. In Table 4, the column marked by a number 15 represents that the aspheric coefficients of the object side surface 15 of the lens 1, and other numbers are interpreted in the same manner.

TABLE 4

| Surface | K | a₄ | a₆ | a₈ | a₁₀ |
|---|---|---|---|---|---|
| 15 | 0.00E+00 | 1.55E−04 | 4.05E−05 | 9.93E−06 | 5.77E−07 |
| 35 | 0.00E+00 | −1.39E−03 | −1.22E−03 | −2.58E−04 | −2.11E−04 |
| 36 | 0.00E+00 | 5.18E−04 | −1.82E−03 | −1.25E−03 | 5.01E−04 |
| 45 | 0.00E+00 | 1.05E−03 | 6.77E−04 | −2.51E−04 | −1.24E−04 |
| 46 | 0.00E+00 | −2.25E−03 | −1.23E−03 | 1.92E−03 | −1.93E−03 |
| 55 | 0.00E+00 | 8.79E−04 | −7.62E−03 | 9.43E−04 | −2.04E−03 |
| 56 | 0.00E+00 | 5.63E−03 | −1.30E−04 | −9.48E−04 | 1.08E−04 |
| 65 | 0.00E+00 | −9.38E−03 | 1.49E−03 | −1.00E−03 | 1.12E−04 |
| 66 | 0.00E+00 | −1.30E−02 | −8.00E−04 | 2.88E−06 | 8.17E−06 |

| Surface | a₁₂ | a₁₄ |
|---|---|---|
| 15 | −8.26E−08 | 1.75E−08 |
| 35 | 0.00E+00 | 0.00E+00 |
| 36 | 0.00E+00 | 0.00E+00 |
| 45 | 0.00E+00 | 0.00E+00 |
| 46 | 0.00E+00 | 0.00E+00 |
| 55 | 0.00E+00 | 0.00E+00 |
| 56 | 0.00E+00 | 0.00E+00 |
| 65 | 0.00E+00 | 0.00E+00 |
| 66 | 0.00E+00 | 0.00E+00 |

Please refer to FIG. 2B to FIG. 2D. FIG. 2B illustrates a field curvature aberration curve in a sagittal direction when light with respective wavelengths of 470 nm, 510 nm, 555 nm, 610 nm, and 650 nm respectively enters the image capturing lens 10 provided in the second embodiment. FIG. 2C illustrates the field curvature aberration curve in a tangential direction when light with respective wavelengths of 470 nm, 510 nm, 555 nm, 610 nm, and 650 nm respectively enters the image capturing lens 10 provided in the second embodiment. FIG. 2D illustrates a distortion curve when light with respective wavelengths of 470 nm, 510 nm, 555 nm, 610 nm, and 650 nm respectively enters the image capturing lens 10 provided in the second embodiment.

In the two field curvature aberration curves shown in FIG. 2B and FIG. 2C, the field curvature aberrations of the five representative wavelengths fall within +0.10 mm across the entire FOV, indicating that the image capturing lens 10 provided in the second embodiment of the disclosure effectively eliminates the aberrations. In the distortion curve shown in FIG. 2D, the distortion aberrations of the five representative wavelengths are less than 2.3224% across the entire FOV, indicating that the image capturing lens 10 provided in the second embodiment of the disclosure has the favorable imaging quality.

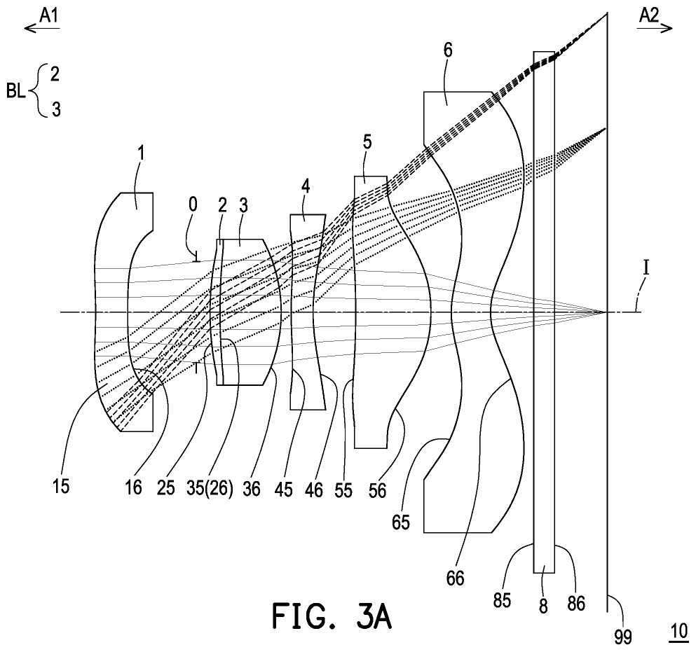

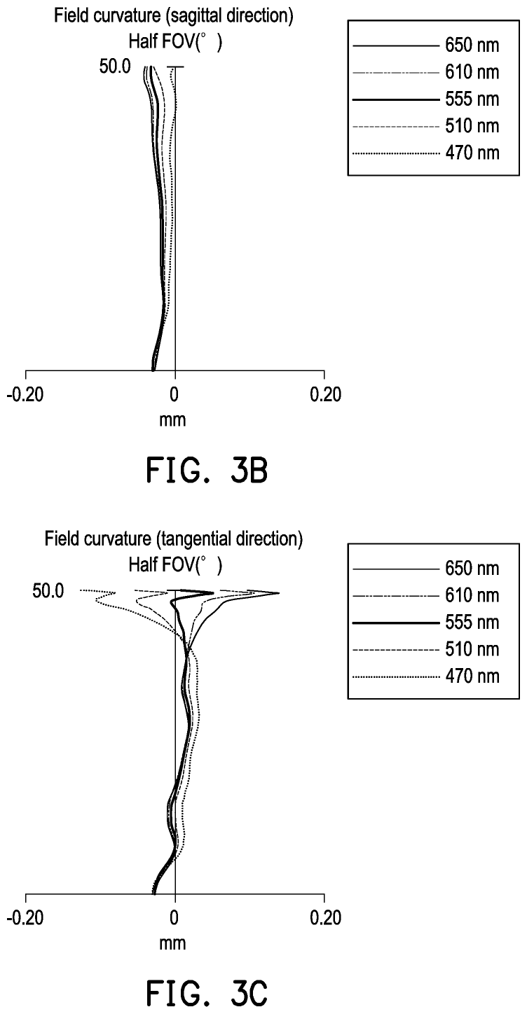

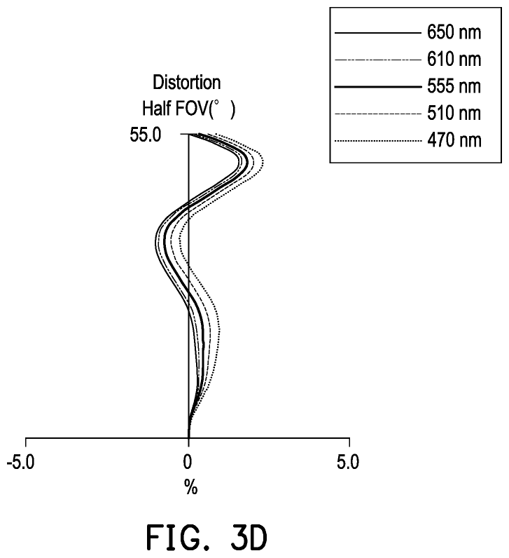

Please refer to FIG. 3A, which is a schematic view illustrating an image capturing lens according to a third embodiment of the disclosure. An image capturing lens 10 provided in the third embodiment of the disclosure sequentially includes a lens 1, an aperture 0, lenses 2 to 6, and a filter 8 along an optical axis I of the image capturing lens 10 from an object side A1 to an image side A2. The lens 2 is a liquid lens, the lens 3 is a spheric lens, and the lenses 2 and 3 are cemented to form a cemented lens BL. When light rays emitted from an object to be shot enter the image capturing lens 10 and sequentially pass through the lens 1, the aperture 0, the lenses 2 to 6, and the filter 8, an image is formed on an image plane 99. The filter 8 is disposed between the lens 6 and the image plane 99.

In this embodiment, each of the lenses 1, 2, 3, 4, 5, 6, and the filter 8 of the image capturing lens 10 has an object side surface 15, 25, 35, 45, 55, 65, and 85 facing the object side A1 and allowing imaging light to pass through, and each of the lenses 1, 2, 3, 4, 5, 6, and the filter 8 has an image side surface 16, 26, 36, 46, 56, 66, and 86 facing the image side A2 and allowing the imaging light to pass through. In this embodiment, the lenses 2 and 3 are cemented together through the image side surface 26 of the lens 2 and the object side surface 35 of the lens 3, thus forming the cemented lens BL with a positive refracting power.

The lens 1 has a negative refracting power, an optical axis region on the object side surface 15 of the lens 1 is a concave surface, an optical axis region on the image side surface 16 of the lens 1 is a concave surface, and both the object side surface 35 and the image side surface 36 are aspheric surfaces.

The cemented lens BL has a positive refracting power, an optical axis region on the object side surface 25 of the cemented lens BL is a convex surface, an optical axis region on the image side surface 36 of the cemented lens BL is a concave surface, the object side surface 25 is a spheric surface, and the image side surface 36 is an aspheric surface. Specifically, by cementing the liquid lens 2 on the easier-to-mold spheric lens 3, the aspheric object side surface 25 is generated, whereby the aspheric cemented lens BL is formed. This greatly reduces the difficulty of manufacturing aspheric lenses as provided in the related art.

The lens 4 has a negative refracting power, an optical axis region on the object side surface 45 of the lens 4 is a convex surface, an optical axis region on the image side surface 46 of the lens 4 is a concave surface, and both the object side surface 45 and the image side surface 46 are aspheric surfaces.

The lens 5 has a positive refracting power, an optical axis region on the object side surface 55 of the lens 5 is a concave surface, an optical axis region on the image side surface 56 of the lens 5 is a convex surface, and both the object side surface 55 and the image side surface 56 are aspheric surfaces.

The lens 6 has a negative refracting power, an optical axis region on the object side surface 65 of the lens 6 is a convex surface, an optical axis region on the image side surface 66 of the lens 6 is a concave surface, and both the object side surface 65 and the image side surface 66 are aspheric surfaces.

Other detailed optical data provided in the third embodiment are shown in Table 5. The full FOV of the image capturing lens 10 is 110.0°.

TABLE 5

| | | Curvature | | Refrac- | |
|---|---|---|---|---|---|
| | | radius | Pitch | tive | Abbe |
| Element | Surface | (mm) | (mm) | index | number |
| Lens 1 | Object side surface 15 | −4.553 | 0.322 | 1.53 | 55.83 |
| | Image side surface 16 | 13.726 | 0.688 | | |
| Aperture 0 | | Infinite | 0.138 | | |
| Lens 2 | Object side surface 25 | 3.036 | 0.08 | 1.62 | 26.13 |
| Lens 3 | Object side surface 35 | 6.587 | 0.614 | 1.96 | 17.5 |
| | Image side surface 36 | −1.533 | 0.100 | | |
| Lens 4 | Object side surface 45 | 4.127 | 0.220 | 1.67 | 19.44 |
| | Image side surface 46 | 1.808 | 0.428 | | |
| Lens 5 | Object side surface 55 | −8.418 | 0.756 | 1.54 | 56.11 |
| | Image side surface 56 | −1.435 | 0.205 | | |
| Lens 6 | Object side surface 65 | 0.989 | 0.393 | 1.64 | 23.51 |
| | Image side surface 66 | 0.652 | 0.434 | | |
| Filter 8 | Object side surface 85 | Infinite | 0.210 | 1.52 | 64.17 |
| | Image side surface 86 | Infinite | 0.492 | | |
| | Image plane 99 | Infinite | | | |

In Table 5, a pitch of the object side surface 15 (as shown in Table 5, as 0.322 mm) is a thickness of the lens 1 on the optical axis I, and a pitch of the image side surface 16 (as shown in Table 5, as 0.688 mm) is a distance between the image side surface 16 of the lens 1 and the aperture 0 on the optical axis I, a pitch of the aperture 0 (as shown in Table 5, as 0.138 mm) is a distance between the aperture 0 and the object side surface 25 of the lens 2, and the rest may be deduced therefrom.

In the present embodiment, the object side surfaces 15, 25, 45, 55, and 65 of the lenses 1, 2, 4, 5, and 6 and the image side surfaces 16, 46, 56, and 66 of the lenses 1, 4, 5, and 6 are all aspheric surfaces, and these aspheric surfaces are defined by the formula (1).

In the present embodiment, the conic coefficient K in the formula (1) and various aspheric coefficients are as shown in Table 6. In Table 6, the column marked by a number 15 represents that the aspheric coefficients of the object side surface 15 of the lens 1, and other numbers are interpreted in the same manner.

TABLE 6

| Surface | K | a₄ | a₆ | a₈ | a₁₀ |
|---|---|---|---|---|---|
| 15 | 0.00E+00 | 4.40E−01 | −1.80E−02 | 7.63E−03 | −2.15E−03 |
| 16 | 0.00E+00 | 2.58E−01 | 1.41E−02 | 7.92E−03 | 1.32E−03 |
| 25 | 0.00E+00 | 1.44E−02 | −2.11E−02 | −2.54E−02 | 3.59E−02 |
| 45 | 0.00E+00 | −4.82E−02 | −1.02E−03 | 1.71E−03 | −3.62E−04 |
| 46 | 0.00E+00 | −1.12E−01 | 1.34E−02 | −2.11E−03 | 8.20E−04 |
| 55 | 0.00E+00 | 9.54E−02 | 1.42E−02 | −4.45E−03 | −1.04E−03 |
| 56 | 0.00E+00 | 1.41E−01 | 1.02E−01 | −1.83E−02 | −8.88E−04 |
| 65 | 0.00E+00 | −9.45E−01 | 1.66E−01 | −4.17E−02 | 1.46E−02 |
| 66 | 0.00E+00 | −1.50E+00 | 2.99E−01 | −1.12E−01 | 4.39E−02 |
| Surface | a₁₂ | a₁₄ | a₁₆ | a₁₈ | a₂₀ |
| 15 | 9.03E−05 | −2.45E−04 | 3.91E−05 | −2.16E−05 | 2.08E−05 |
| 16 | 4.22E−04 | 6.78E−06 | −1.52E−06 | −2.80E−05 | −7.95E−07 |
| 25 | −6.38E−13 | 0.00E+00 | 0.00E+00 | 0.00E+00 | 0.00E+00 |
| 45 | 1.27E−04 | −5.18E−05 | 1.78E−05 | −3.81E−06 | 2.93E−07 |
| 46 | −2.37E−04 | 8.23E−05 | −3.28E−05 | 1.31E−05 | −2.43E−06 |
| 55 | 6.34E−04 | −2.99E−04 | 8.80E−05 | −2.49E−05 | 8.91E−06 |
| 56 | −1.75E−03 | 1.07E−03 | −2.69E−04 | 6.78E−05 | −1.22E−05 |
| 65 | 3.10E−04 | −1.32E−03 | 2.09E−04 | −1.62E−04 | 3.10E−05 |
| 66 | −1.51E−02 | 5.42E−03 | −1.79E−03 | 6.01E−04 | −1.63E−04 |

Please refer to FIG. 3B to FIG. 3D. FIG. 3B illustrates a field curvature aberration curve in a sagittal direction when light with respective wavelengths of 470 nm, 510 nm, 555 nm, 610 nm, and 650 nm respectively enters the image capturing lens 10 provided in the third embodiment. FIG. 3C illustrates the field curvature aberration curve in a tangential direction when light with respective wavelengths of 470 nm, 510 nm, 555 nm, 610 nm, and 650 nm respectively enters the image capturing lens 10 provided in the third embodiment. FIG. 3D illustrates a distortion curve when light with respective wavelengths of 470 nm, 510 nm, 555 nm, 610 nm, and 650 nm respectively enters the image capturing lens 10 provided in the third embodiment.

In the two field curvature aberration curves shown in FIG. 3B and FIG. 3C, the field curvature aberrations of the five representative wavelengths fall within +0.20 mm across the entire FOV, indicating that the image capturing lens 10 provided in the third embodiment of the disclosure effectively eliminates the aberrations. In the distortion curve shown in FIG. 3D, the distortion aberrations of the five representative wavelengths are less than 2.5880% across the entire FOV, indicating that the image capturing lens 10 provided in the third embodiment of the disclosure has the favorable imaging quality.

To sum up, the image capturing lens provided in one or more of the embodiments of the disclosure integrates both the liquid lens and the solid lens to form the cemented lens. The remarkable plasticity of the liquid lens enables dynamic adjustments to the overall refractive index, the surface shape, the curvature radius, and other optical characteristics of the cemented lens, which represents a significant leap beyond the manufacturing limitations typically tied to the conventional solid lenses.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. An image capturing lens, comprising:
a cemented lens, having a positive refracting power and comprising a spheric lens and a liquid lens,
wherein in addition to the cemented lens, the image capturing lens comprises 4 or 5 lenses with refracting powers.

2. The image capturing lens according to claim 1, wherein the liquid lens comprises ultraviolet resin.

3. The image capturing lens according to claim 1, wherein the liquid lens comprises an aspheric profile.

4. The image capturing lens according to claim 1, wherein a refractive index of the spheric lens falls within a range from 1.5 to 1.96, and a refractive index of the liquid lens falls within a range from 1.5 to 1.62.

5. The image capturing lens according to claim 1, wherein a thickness of the liquid lens on an optical axis is less than or equal to 0.100 mm.

6. The image capturing lens according to claim 1, further comprising a first lens, a second lens, a third lens, a fourth lens, and a fifth lens which are sequentially disposed from an object side to an image side, wherein the cemented lens is disposed at the object side of the first lens.

7. The image capturing lens according to claim 6, wherein the cemented lens, the first lens, the second lens, the third lens, the fourth lens, and the fifth lens respectively have a positive refracting power, a negative refracting power, a positive refracting power, a negative refracting power, a positive refracting power, and a negative refracting power.

8. The image capturing lens according to claim 1, further comprising a first lens, a second lens, a third lens, and a fourth lens which are sequentially disposed from an object side to an image side, wherein the cemented lens is disposed at the object side of the first lens.

9. The image capturing lens according to claim 8, wherein the cemented lens, the first lens, the second lens, the third lens, and the fourth lens respectively have a positive refracting power, a positive refracting power, a negative refracting power, a positive refracting power, and a positive refracting power.

10. The image capturing lens according to claim 1, further comprising a first lens, a second lens, a third lens, and a fourth lens which are sequentially disposed from an object side to an image side, wherein the cemented lens is disposed between the first lens and the second lens.

11. The image capturing lens according to claim 10, wherein the first lens, the cemented lens, the second lens, the third lens, and the fourth lens respectively have a negative refracting power, a positive refracting power, a negative refracting power, a positive refracting power, and a negative refracting power.

12. The image capturing lens according to claim 1, wherein a curvature radius of an object side surface of the liquid lens is different from a curvature radius of an image side surface of the liquid lens.
